(19) United States
(12) Patent Application Publication
(10) Pub. No.: US 2009/0258971 A1
(43) Pub. Date: Oct. 15, 2009

(54) Composites Containing Acrylate Hybride Resin Based On Natural Fatty Acids

(75) Inventors: Nina Heiskanen, Helsinki (FI); Pia Willberg, Espoo (FI); Salme Koskimies, Helsinki (FI); Janne Hulkko, Lohja (FI); Pirita Ushanov, Helsinki (FI); Sirkka-Liisa Maunu, Helsinki (FI)

Correspondence Address: BIRCH STEWART KOLASCH & BIRCH, PO BOX 747, FALLS CHURCH, VA, 22040-0747, US

(73) Assignee: Valtion teknillinen tutkimuskeskus, Espoo (FI)

(21) Appl. No.: 12/224,615

(22) PCT Filed: Mar. 2, 2007
(86) PCT No.: PCT/FI2007/050113

§ 371 Date: Oct. 30, 2008

(30) Foreign Application Priority Data
Mar. 6, 2006 (FI) 20065148

(51) Int. Cl. C08L 97/02; C08K 11/00; C08L 1/02; C08L 3/02

(52) U.S. Cl. 524/14; 524/13; 524/9; 524/35; 524/47

(57) ABSTRACT

The invention relates to natural fatty acid based hybride resins, which have been modified with reactive monomers, such as acrylates, and especially to their use as binding agents and compatibilisators in combination products such as composites, as well as to composites containing them and to a method for the manufacture of the composites. The combination product comprises 1-50 weight-%, calculated from the dry matter, of a natural fatty acid based acrylate hybride resin, either as such or as an aqueous emulsion, and 99-50 weight-% of cellulose, wood, linen, hemp, starch or other natural fibre material or a combination thereof.

### FIELD OF THE INVENTION

The invention relates to natural fatty acid based hybride resins modified with reactive monomers such as acrylates, and especially to their use as binding agents and compatibilisators in composites, as well as to composites containing them.

### PRIOR ART

Use of products manufactured from renewable raw materials or biomaterials such as biocomposites is increasing continuously. This is a result of many good properties of these products, which are among other things the biodegradability, recyclability and low toxicity of the products. Of their volume point of view, the most important of present biocomposites are composites based on linen fibres, hemp fibres and wood fibres. In order to reach as high proportion of raw materials derived from natural materials in the biocomposites as possible, it is generally desirable that the additives used in the preparation are also biobased.

Emulsion polymerisation is a known method for the preparation of synthetic latexes such as styrene-butadiene copolymers, acrylic polymers and poly(vinyl acetate), functioning as paints and binding agents. In emulsion polymerisation typically water, a monomer or monomer mixture, a surfactant and a polymerisation initiator are used. In the field also emulsion polymerisation-like miniemulsion polymerisation processes are known in which often additionally e.g. a cosurfactant is used.

Patent U.S. Pat. No. 6,369,135 discloses a miniemulsion polymerisation method for the preparation of a latex suitable for coating applications, in which process the reaction product of a diol or polyol, such as ethylene glycol or glycerol and a mono- or polybasic acid such as phthalic anhydride, or alkyd resin, modified with linen seed oil or soy oil, is dissolved in an ethylenically unsaturated monomer such as a vinyl or acrylate monomer. The mixture is miniemulsion polymerised in the presence of water and a surfactant and preferably in the presence of an additional cosurfactant. As a result, latex comprising polymer particles is obtained, in which polymer the alkyd is grafted to an acrylate polymer skeleton or vice versa the acrylate is grafted to an alkyd polymer skeleton.

Based on the above one can see that there exists a need for providing new composites and combination products containing natural fatty acid based acrylate hybride resins.

### OBJECT OF THE INVENTION

An object of the invention is the use of natural fatty acid based acrylate hybride resins as binding agents and compatibilisators in combination products such as composites, especially biocomposites.

Another object of the invention is also a combination product such as a composite comprising natural fatty acid based acrylate hybride resins.

Another object of the invention is a method for the preparation of a combination product such as composite comprising natural fatty acid based acrylate hybride resins.

The characterising features of the use of the natural fatty acid based acrylate hybride resins according the invention, and of combination products containing them, such as composites, especially biocomposites, are presented in the patent claims.

Natural fatty acid based acrylate hybride resins refer here to polymers formed of acrylate monomers and natural fatty acid based alkyd resins, the type of the polymers being mainly blockpolymers.

### SUMMARY OF THE INVENTION

The invention relates to the use of natural fatty acid based acrylate hybride resins as binding agents and compatibilisators in combination products such as composites, especially in biocomposites, as well as to combination products such as composites and especially biocomposites comprising natural fatty acid based acrylate hybride resins.

Natural fatty acid based acrylate hybride resins may be used as binding agents and compatibilisators for the preparation of combination products such as composites from natural materials such as cellulose, wood, wood fibres, linen, hemp, starch and other natural fibres or combinations thereof, when necessary with known additives and optionally with other materials.

The composites according to the invention comprise natural fatty acid based acrylate hybride resins having a molecular weight of 800-6,000,000 and comprising fatty acid based alkyd segments having a molecular weight of 200-20,000 and acrylate segments.

Natural fatty acid based acrylate hybride resins may be produced by an emulsion polymerisation method, in which reactive acrylate monomers are allowed to react with conjugated or non-conjugated double bonds of the fatty acid part of a natural fatty acid based alkyd resin whereby the desired natural fatty acid based acrylate hybride resin is formed.

In the emulsion polymerisation method the natural fatty acid based alkyd resin is first dissolved or mixed into an acrylate monomer or an acrylate monomer mixture, then the solution is dispersed into water in the presence of one or several surfactants and optionally one or more cosurfactants to form an emulsion, and then polymerisation is carried out with radical mechanism in the presence of a suitable free radical initiator. The product emulsion contains polymer particles, wherein acrylate polymer chains have been grafted to the double bonds of the fatty acids of the starting material, e.g. an acrylate polymer segment is attached to the fatty acid side chain of the alkyd.

### DETAILED DESCRIPTION OF THE INVENTION

It was surprisingly found that natural, biodegradable and non-toxic combination products, such as composites and especially biocomposites may be produced from natural fatty acid based acrylate hybride resins and natural fibre materials.

The composite according to the invention containing a natural fatty acid based acrylate hybride resin comprises 1-50, preferably 5-30 weight-% (calculated from dry matter) of natural fatty acid based acrylate hybride resin, and 99-50, preferably 95-70 weight-% cellulose, wood, wood fibres, linen, hemp, starch or other natural fibre material or a combination thereof when necessary with known additives, or alternatively, together with the natural materials other material selected from thermoplastic plastics such as polyolefins, polyamides, polyesters, polyethyleneterephthalates (PET), polylactides (PLA) and corresponding polymers, which may be recycled material, may be used in the composites.

The composite according to the invention containing natural fatty acid based acrylate hybride resin can be produced by mixing 1-50, preferably 5-30 weight-% of a natural fatty acid based acrylate hybride resin as such or as a water emulsion and 99-50, preferably 95-70 weight-% of cellulose, wood, wood fibres, linen, hemp, starch or other natural fiber material or a combination thereof, by forming and curing the product with aid of heat, e.g. by extrusion or hot-pressing at 100-250° C., preferably 120-200° C. to a composite product of desired type. 20-80 weight-% of the natural fibre material may be replaced with other material, which can be selected from thermoplastic plastics such as polyolefins, polyamides, polyesters, polyethyleneterephthalates (PET), polylactides (PLA) and corresponding polymers, which material is preferably recycled material, which is ground or crushed to fine crush. 30-70 weight-% of the natural fatty acid based acrylate hybride resin may be replaced with other binder or adhesive, particularly in wood board products, such as plywood and veneer products with adhesives originating from the nature, such as starch and cellulose derivatives.

In the manufacture of natural fatty acid based acrylate hybride resins mixtures of natural fatty acids and mixtures of natural fatty acid esters may be used, containing fatty acids or corresponding esters containing double bonds, existing e.g. in plants, trees and especially in natural oils, tall oil fatty acid mixtures and in fatty acid mixtures of suberin and cutin, where the double bonds may be conjugated or non-conjugated. Natural oils refer here to natural oils containing conjugated or non-conjugated double bonds, such as plant oil, preferably linen seed oil, soy oil, rapeseed oil, rape oil, sunflower oil, olive oil and corresponding oils.

Tall oil fatty acid mixture refers particularly to fatty acid mixture separated from the tall oil side product of wood processing industry, the typical fatty acid composition of being presented in the following. The tall oil fatty acid mixture contains about 50% (45-55%) of linolic acid and other diunsaturated C18-fatty acids, including conjugated acids, about 35% (30-45%) of oleic acid, about 7% (2-10%) of polyunsaturated fatty acids, about 2% (0.5-3%) of saturated fatty acids and not more than 3% (0.5-3%) of rosin acids, calculated as weight percents.

Suggestive fatty acid compositions of certain natural oils as weight percentages are presented in the following Table 1:

TABLE 1

| | Fatty acid composition (weight %) | | | |
|---|---|---|---|---|
| | Soy | Linen | Rapeseed | Tall oil fatty |
| Fatty Acid | oil | seed oil | oil | acid mixture |
| Saturated | | | | |
| C₁₄ myristic acid | 0.1 | | | |
| C₁₆ palmitic acid | 10.5 | 6 | 5 | |
| C₁₈ stearic acid | 2 | 3.5 | 2 | 2 |
| C₂₀ arachidic acid | 0.2 | | | 1 |
| Unsaturated | | | | |
| C_{16:1} palmitoleic acid | | 0.5 | | |
| C_{18:1} oleic acid | 22.3 | 19 | 63 | 59 |
| C_{20:1} eicosenoic acid | 0.9 | | 1 | 1 |
| C_{18:2} linolic acid | 54.5 | 14 | 20 | 37 |
| C_{18:3} linolenic acid | 8.3 | 57 | 9 | |
| Altogether | 98.8 | 100 | 100 | 100 |

Natural fatty acid based alkyd resin refers here to a condensation product of a polyhydric alcohol/alcohols and a mono-, di- and/or polyacid/-acids or anhydride and natural fatty acids or natural fatty acid esters. The natural fatty acid or natural fatty acid ester comprises a ratty acid mixture or fatty acid ester mixture selected from the group consisting of tall oil fatty acids, suberin fatty acids and cutin fatty acids and plant oils, preferably tall oil fatty acids, suberin fatty acids, linen seed oil, soy oil, rapeseed oil, rape oil, sunflower oil and olive oil and their mixtures.

Natural fatty acid based alkyd resin refers here to alkyd resin manufactured by condensing 20-80, preferably 40-75 weight-% of fatty acid starting materials or a mixture thereof, in which the proportion of conjugated fatty acids is 0-70 weight-%, with 1-45, preferably 5-30 weight-% of one or several polyols, and 5-45, preferably 10-39 weight-% one or several polybasic acids and optionally 0-15 weight-% one or several monobasic acids. The fatty acid starting material comprises natural fatty acid or natural fatty acid ester selected from the group consisting of tall oil fatty acids, suberin fatty acids and cutin fatty acids, plant oils and their mixtures, preferably tall oil fatty acids, suberin fatty acids, linen seed oil, soy oil, rapeseed oil, rape oil, sunflower oil and olive oil. The polyol is selected from the group consisting of glycerol, pentaerythritol, trimethylolpropane, neopentyl glycol and their mixtures. The polybasic acid is selected from the group consisting of di- and polyacids and their anhydrides, the polybasic acid is preferably phthalic anhydride, isophthalic acid or terephthalic acid. The monobasic acid is selected from the group consisting of aromatic monoacids or aliphatic C₄-C₂₀ carboxylic acids such as valeric acid (n-pentanoic acid) and benzoic acid.

The alkyd resin is prepared by esterifying the polyhydric alcohol(s) with mono-, di- and/or polyacid(s) or anhydride and free fatty acid starting material(s) r under an inert gas at a temperature of 200-270, preferably 220-260° C., under inert gas.

When fatty acid esters such as plant oils are used, the fatty acid esters are first allowed to react at a temperature of 150-240, preferably 180-200° C. with an excess of a polyol in an ester exchange reaction called alcoholysis, whereby to the equilibrium mixture free hydroxyl groups are obtained, which can react further with mono-, di- and/or polyacids or anhydrides at a temperature of 200-270, preferably 220-260° C., under an inert gas. Commonly used alcoholysis catalysts are lithium hydroxide, calcium oxide and sodium hydroxide. For the alcoholysis, the polyol is typically used twice the molar amount of the oil; the oil:polyol mole ratio is typically 1.0:1.2-1.0:3.0, preferably 1.0:1.5-1.0:2.0.

The molecular weight of the natural fatty acid based alkyd resins so prepared is typically <20,000 g/mol, preferably 2,000-10,000 g/mole and the acid number is typically <25, preferably <15.

In the natural fatty acid based alkyd hybrid resin of the composite according to the invention, also natural fatty acid based alkyd resin modified with maleic anhydride or C₁-C₂₀ alkyl/alkenyl derivatives of maleic anhydride or diesters or half esters of maleic anhydride be used. The natural fatty acid based alkyd resin is warmed to a temperature of 100-200, preferably 150-180° C., then maleic anhydride (5-35 mole %, preferably 10-20 mole % of the fatty acid content of the alkyd) is added typically in small portions during 0.5-2 hours, after which the reaction mixture is warmed to 150-220, preferably 1 80-200° C. and agitated further for 1-5 hours. As a product a modified alkyd resin is obtained having a higher acid functionality than the alkyd resin used as starting material.

Acrylate monomers refer here to acrylate and methacrylate monomers such as butyl, ethyl, methyl and 2-ethylhexyl acrylate and butyl, ethyl, methyl and 2-ethylhexyl methacrylate, acrylic acid and methacrylic acid, a mixture of acrylate monomers as well a mixture of acrylate or methacrylate with styrene or vinyl alcohol or vinyl acetate. Preferred acrylate monomers are butyl acrylate, methyl methacrylate and butylmethacrylate.

The natural fatty acid based acrylate hybride resin is prepared by emulsion polymerising natural oil based alkyd resin with acrylate monomer in an aqueous solution in the presence of radical catalyst at a temperature of 30-100° C., preferably 50-90° C., whereby a stable emulsion is formed. Typical polymerising time is 1-6 hours.

Acrylate monomer(s) and water are dispersed in the presence of one or several surfactants as well as optionally one or several cosurfactants to an emulsion, and then the acrylate monomer or the mixture of acrylate monomers are polymerised in the presence of free radical initiator and natural fatty acid based alkyd resin.

Alternatively the acrylate monomer or the acrylate monomers, water, alkyd resin and one or several surfactants and optionally one or several cosurfactants (hydrofob) are mixed together using heating if necessary, typically 20-80° C./1-120 min, preferably 25-65° C./1-30 min, after which pH of the solution is adjusted between 6-9, suitable bases for pH adjustment are e.g. NaHCO₃ (aq), KOH (aq), NH₃ (aq), and the like. The reaction mixture is then emulsified to an aqueous solution, which possibly contains one or several surfactants. The emulsifying can be carried out either by adding the organic phase into the aqueous phase or vice versa, agitating at the same time vigorously, typically for 1-1 80 min, preferably 5-60 min. The mixing can also be carried out with a high efficiency mixing method or the emulsion first formed is treated with a high shear force blender in order to form emulsion droplets. Typically ultrasonication can be used for 1-60 min, preferably 5-30 min, or a high shear blender using a speed of revolution of 200-50,000 rpm, preferably 1,000-25,000 rpm, for 0.5-10 min, preferably 1-5 min. A typical high efficiency blender is e.g. the Ultra Turrax homogenisator. The emulsion is transferred to a polymerising reactor and is warmed to a reaction temperature of 30-100, preferably 55-80° C. When the content of the reactor has reached a temperature of 45-85° C., an aqueous solution of polymerising initiator is added if the polymerising initiator hasn't been added earlier already. The polymerising is carried out in the presence of the polymerising initiator at a temperature of 30-100, preferably 50-90° C., polymerising time 1-6 hours, preferably 2-4 hours, with mixing speeds of revolution of 100-2,000 rpm, preferably 300-500 rpm. After the reaction time the reaction mixture is cooled to room temperature, if necessary the pH is adjusted to the range of 7-9 and optional additives such as biocide is added. The dry matter content of the emulsion is typically 8-85, preferably 35-60 weight-% and conversion of the monomer 50-100%.

The ratio of the alkyd resin and acrylate monomer in the emulsion polymerisation method is typically between 30-70: 70-30 weight/weight.

The surfactant i.e. surface active agent is selected from the group consisting of alkyl sulfates, such as sodium dodecyl sulphate, ethoxylated alkyl sulfates, such as sodium laurylether sulphate, alkyl sulfonates, fatty acid salts, ethoxylated fatty acids, polyoxyethylene ethers, such as polyoxytridecyl ether, polyoxyethylene-10-stearyl ether or decaethylene glycol octadecyl ether, polyethylene glycols, polyethylene glycol methyl ether, polyethylene glycol methacrylate, and other conventional non-ionic and ionic surfactants. The amount of surfactant is typically 0.5-15 weight-% calculated from the monomer, preferably 1-10 weight-%.

The cosurfaktant is selected from the group consisting of a long-chain hydrocarbons, such as hexadecane, 1-alcohols, such as cetyl alcohol and polymers soluble in acrylate monomers, such as poly(methyl methacrylate). The cosurfactant is typically used in an amount of 0-8 weight-% of the amount of the monomer.

The polymerising initiator (free radical initiator) is selected from the group consisting of persulfates, such as sodium, potassium and ammonium persulfate, benzoyl peroxide, 2,2′-azobisisobutyronitrile and other radical intiators, using typically concentrations of about 0.5-1.0 weight-% of the monomer.

The amount of the polymerising initiator in water solution is typically 1-5, preferably 2-3.5 weight-%. The water solution of the polymerising initiator is typically added during 10 minutes to 2 hours.

The average hydrodynamic radius (Rₕ) of particles of the natural fatty acid based acrylate hybride resin is 70-200 nm and size distribution 25-400 nm, average molecular weight M_{w} 8,000-6,000,000 g/mole. Three glass transition temperatures are typically visible in the DSC curves of the hybride products. The glass transition temperature (T_{g}) can be determined by differential scanning calorymetry (DSC).

It was surprisingly found that natural fatty acid based acrylate hybride resins can be used as binding agents (binders) and compatibilisators in the manufacture of combination products (composites) such as biocomposites and especially wood, wood fibre, hemp and linen composites. The properties of the binding agent, such as water dispersibility and/or adhesive properties e.g. to natural materials such as wood, hemp and linen are excellent and the compatibility of the natural fatty acid based acrylate hybride resins with natural materials such as wood, hemp and cellulose is also flawless.

With the aid of the natural fatty acid based acrylate hybride resins, a very high proportion of raw materials derived from natural materials in biocomposite products is reached, and thus in the composites also the emissions of volatile organic substances can be reduced substantially.

In the composite according to the invention a natural fatty acid based acrylate hybride resin is used as binding agent, to the preparation of which a hydrophobic polymer is used, to which an acrylate polymer segment is polymerised. As the result of this the compatibility especially with the biomaterials used in the invention will increase.

The invention is described in more detail with the following examples, to which it is anyhow not meant to be restricted.

### EXAMPLES

### Example 1

### Preparation a Tall Oil Based Alkyd Resin

Alkyd resin was prepared from tall oil fatty acids (372.6 g), isophthalic acid (55.9 g) and trimethylolpropane (93.8 g). The reaction mixture was agitated and warmed at 230-260° C. The progress of the reaction was followed by taking samples, from which acid number, and when the reaction mixture became clear, the viscosity (R.E.L. Cone/Plate Viscometer) were determined. The reaction was boiled for 6 hours. From the cooled product (455g) the acid number (12) and viscosity (2,193 cP/RT=at room temperature, Brookfield Synchro-Lectric Viscometer) were determined.

### Example 2

### Preparation of Linen Seed Oil Based Alkyd Resin

Alkyd resin was prepared from linen seed oil (865.7 g), trimethylol propane (402.0 g), isophthalic acid (300.0 g) and benzoic acid (294.3 g). 860 g of linen seed oil was warmed to a temperature of 150° C. with agitaton under nitrogen atmosphere. Lithium hydroxide monohydrate was added as suspended to 5.7 g of linseed oil. Heating was continued to 200° C. and trimethylol propane was added. The alcoholysis reaction was followed with a dissolution test. When the reaction mixture was fully soluble in methanol, isophthalic acid was added into the reaction vessel, and after stirring benzoic acid was added. The heating of the reaction mixture was continued at 200-250° C. and the progress of the reaction was followed by determining acid number, and when the reaction mixture became clear, also with viscosity. The reaction was boiled for 3.5 hours from the acid addition. From the cooled product (1.584 g) acid number (14 mgKOH/g) and viscosity (5.4 Poise/50° C./R.E.L. Cone/Plate Viscometer) were determined.

### Example 3

### Modifying of Tall Oil Fatty Acid Based Alkyd Resin with Acrylates

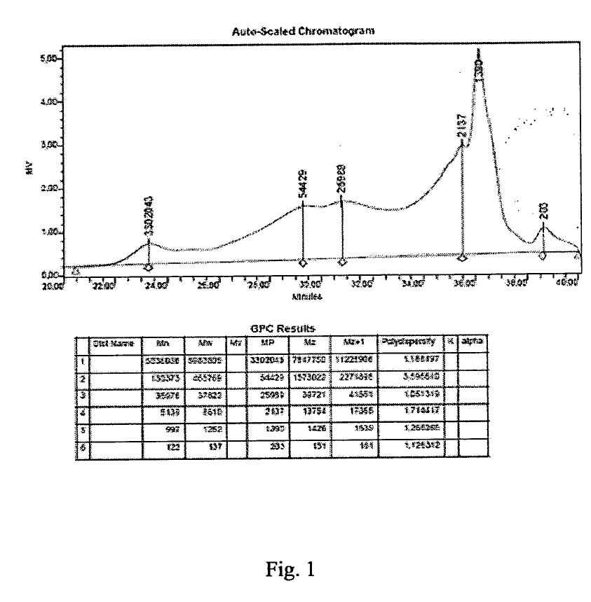

150 g of the alkyd resin of example 1 was weighed and 3 g of sodium dodecyl sulfate and 16.5 g of Brij 76 (decaethylene glycol octadecyl ether) were mixed into it. The mixture was warmed to 60° C., whereby the mixture became homogeneous. The mixture was neutralised with 25 ml of 1 M sodium bicarbonate. 150 g of butyl acrylate and 9 g of hexadecane were mixed together and added slowly to the alkyd resin mixture. The mixture was agitated for about 15 min 500 rpm. An emulsion started to form when 250 ml of water was added to the mixture drop wise during about half an hour. After this the warming was discontinued and 200 ml of water was added slowly to the mixture. The mixture was agitated further for about 15 min (500 rpm) as well as for about 5 min with an Ultra Turrax homogeniser 10,000-14,000 rpm. After this the emulsion was added to a glass reactor and the reactor was purged with nitrogen gas. The bath was warmed to 70° C. while the speed of revolution was 400 rpm. When the inner temperature of the reactor was 50° C., 20 ml/min of an initiator solution (6.7 g of potassium persulfate and 150 ml of water) was added to the reactor. After 3 hours of polymerisation (at a temperature of 65-66° C.) the temperature was decreased to 30° C. and the emulsion/dispersion was drained from the reactor. The dry matter content of the final emulsion was 28% and conversion of the monomer 82% (determined gravimetrically) and pH 7.8. The degree of grafting was 75%, the average hydrodynamic radius Rₕ (particle size) of the hybride polymers 150 nm and largest average molecular weight M_{w} 6,000,000 g/mole. The magnitude of the molecular weight distribution can be seen from the GPC chromatogram presented in the appended FIG. 1. Small values (<3,000) originate from the alkyd. The polydispercity PDI (measure of molecular weight distribution) is large, the values in the table depict only the dispercity of each selected peak.

### Example 4

### Modifying of Tall Oil Fatty Acid Based Alkyd Resin with Acrylates

150 g of the alkyd resin of example 1 was weighed and 3 g of sodium dodecyl sulfate and 5.0 g of Brij 76 (decaethyleneglycol octadecyl ether) were mixed with it. The mixture was agitated at 60° C., when the mixture became homogeneous. The mixture was neutralised with 15 ml of 1M sodium bicarbonate. 150 g of butyl acrylate and 9 g of hexadecane were mixed together and added slowly to the alkyd resin mixture. 425 ml of water was added to the mixture during about half an hour, heating was stopped at the final stage. The emulsion was agitated further for 15 min and for about 5 minutes with Ultra Turrax homogeniser 13,500 rpm. Then the emulsion was added to a glass reactor and the reactor was purged with nitrogen. The bath was warmed to 80° C. while the speed of revolution was 400 rpm. When the inner temperature of the reactor was 60° C., 20 ml/min of initiator solution (5.0 g of potassium persulfate and 150 ml of water) was added to the reactor. After 4 hours of polymerisation (inner temperature about 66-70° C.) the temperature was decreased to 30° C. and the emulsion/dispersion was drained from the reactor. The final dry matter content of the emulsion was 30%, monomer conversion 85% (determined gravimetrically) and pH 5.6.

### Example 5

### Modifying of Linen Seed Oil Based Alkyd Resin with Acrylates

The linen seed oil based alkyd resin of example 2 (151.3 g), hexadecane (9g), Brij76 (5 g) and butyl acrylate (150.1 g) were mixed and warmed as homogeneous at 60° C. The mixture was neutralised (pH 7) with an aqueous sodium bicarbonate solution (1M NaHCO₃, 15 ml). Sodium dodecyl sulfate (3 g) was dissolved in water (450 ml) and the solution was added drop wise during about one hour (warming off) to the alkyd resin mixture to be mixed. The emulsion was agitated further for about 15 min (about 1,300 rpm) as well as for about 5 min with Ultra Turrax homogeniser 13,500 rpm. Then the emulsion was added to a glass reactor and the reactor was purged with nitrogen gas. The bath was warmed to 75° C. while the speed of revolution was 400 rpm. When the inner temperature of the reactor was 50° C., 20 ml/min of initiator solution (5.2 g of potassium persulfate dissolved in 150 ml of water) was added to the reactor. After 4 hours of polymerisation (inner temperature about 66-70° C.) the temperature was allowed to decrease to 30° C. and the emulsion/dispersion was drained from the reactor. The dry matter content of the final emulsion was 25% and monomer conversion was 72% (determined gravimetrically, 105° C./l hour) and pH 6.0.

### Example 6

### Preparation of a Composite Board from the Natural Fatty Acid Based Acrylate Hybride Resin

A composite board was produced using 180 g of the natural fatty acid based acrylate hybride resin prepared according to example 5 and about 80 weight-% of a wood fibre (fibre type wood particulate). The compounding time was 20 min, adaptation time in press ram 2 min, hot moulding temperature 180-160° C. and time 30 min, conditioning 60 min, total time 2 hours, thickness of the board 4.8 mm. Thus a ready composite board was obtained having a density of 959 kg/m³, moisture content 4.4%, expansion during 24 hours 32% of the thickness, bond strength 0.4 N/mm² and flexural strength 7.4 N/mm².

### Example 7

### Manufacture of Acrylate Modified Natural Fatty Acid Based Hybride Polymer from Linen Seed Oil

3 g of sodium dodecyl sulphate and 15.0 g of of Brij 76 (decaethyleneglycol octadecyl ether) were mixed to 150 g of linen seed oil. The mixture was agitated at 60° C., while it turned homogeneous. The mixture was neutralised with 15 ml of 1M sodium bicarbonate. 170 g of butyl acrylate and 12.1 g of hexadecane were mixed together and added slowly to the previous solution. 450 ml of water was added drop wise to the monomer mixture and heating was ceased. The emulsion was agitated further with magnet mixer and for about 5 min with Ultra Turrax homogeniser 13,500 rpm. Then the emulsion was added to a glass reactor and nitrogen flow was connected to the reactor. The bath was warmed to 75° C. while the speed of revolution was 430 rpm. When the inner temperature of the reactor was 50° C., 20 ml/min of initiator solution (5.1 g of potassium persulfate and 150 ml of water) was added to the reactor. After 4 hours of polymerisation (inner temperature about 69-70° C.) the temperature was allowed to decrease to about 30° C. and the emulsion obtained as product was drained from the reactor. The dry matter content of the emulsion was 36%.

### Example 8

### Preparation a Tall Oil Based Alkyd Resin

Alkyd resin was prepared from tall oil fatty acids (1484.4 g), isophthalic acid (222.4 g) and trimethylolpropane (375.5 g). All ingredients were weighed to a reactor and the reaction mixture was agitated and warmed at 250-260° C. using nitrogen flow. The progress of the reaction was followed by taking samples, from which acid number, and when the reaction mixture became clear, the viscosity (R.E.L. Cone/Plate Viscometer) were determined. The reaction was boiled for 11 hours. From the cooled product (1875.2 g) acid number (10.3) and viscosity (2.4 Poise/50° C.) were determined.

### Example 9

### Modifying of Tall Oil Fatty Acid Based Alkyd Resin with Maleic Anhydride

400 g of starting material, the alkyd resin manufactured in example 8 (acid number 10.3 mgKOH/g, viscocity 2.4 Poise/50° C.) was weighed to a reaction vessel and the reaction mixture was heated to 180° C. 8.0 g of maleic anhydride (0.163 mol, 15 mol-% of fatty acid concentration of the alkyd) was added in small portions during 1 hour, the the reaction mixture was heated to 200° C. and further agitated for 3 h. 396.9 of final product was obtained with acid number of 19.7 mgKOH/g and viscocity of 4.7 Poise/50° C.

1-22. (canceled)

23. A composite product, characterised in that it comprises 1-50% by weight of a natural fatty acid based acrylate hybride resin, and 99-50% by weight of natural material selected from cellulose, wood, wood fibres, linen, hemp, starch or other natural fiber material or a combination thereof, and optionally 20-80% by weight of the natural material is replaced with material selected from thermoplastics, and optionally 30-70% by weight of the natural fatty acid based acrylate hybride resin is replaced with binding agent or adhesive originating from nature, and the natural fatty acid based acrylate hybride resin is manufactured by emulsion polymerisation in an aqueous emulsion of acrylate monomer onto natural fatty acid based alkyd resin.

24. The composite product according to claim 23, characterised in that it comprises 5-30% by weight of a natural fatty acid based acrylate hybride resin, and 95-70% by weight of natural material and optionally material replacing it.

25. The composite product according to claim 23, characterised in that the natural fatty acid based acrylate hybride resin is a polymer formed of acrylate monomers and natural fatty acid based alkyd resins, having a molecular weight of 800-6,000,000.

26. The composite product according to claim 23, characterised in that the thermoplastics is selected from polyolefins, polyamides, polyesters, polyethyleneterephthalates (PET), polylactides (PLA) and corresponding polymers.

27. The composite product according to claim 23, characterised in that the thermoplastics is recycled material.

28. The composite product according to claim 23, characterised in that the natural fatty acid based acrylate hybride resin is manufactured by emulsion polymerisation in an aqueous emulsion of acrylate monomer onto natural fatty acid based alkyd resin in the presence of radical initiator at a temperature of 30-100° C.

29. The composite product according to claim 28, characterised in that the natural fatty acid based alkyd resin is selected from alkyd resins manufactured by condensing 20-80% by weight of fatty acid starting material or a mixture thereof, 1-45% by weight of one or several polyols, 10-45% by weight of one or several polybasic acids and optionally 0-15% by weight of one or several monobasic acids.

30. The composite product according to claim 29, characterised in that the fatty acid starting material is selected from tall oil fatty acids, suberin fatty acids and cutin fatty acids, plant oils and their mixtures, the polyol is selected from glycerol, pentaerythritol, trimethylol propane, neopentyl glycol and their mixtures, the polybasic acid is selected from di- and polyacids and their anhydrides, and the monobasic acid is selected from valeric acid and benzoic acid.

31. The composite product according to claim 28, characterised in that the natural fatty acid based alkyd resin is modified with maleic anhydride.

32. The composite product according to claim 28, characterised in that the acrylate monomer is selected from acrylate and methacrylate monomers, acrylic acid and methacrylic acid, mixtures of acrylate monomers and mixtures of acrylate or methacrylate with styrene or vinyl alcohol or vinyl acetate.

33. A method for the manufacture of a composite product according to claim 23, characterised in that in the method 1-50% by weight of natural fatty acid based acrylate hybride resin as such or as an aqueous emulsion and 99-50% by weight of natural material selected from cellulose, wood, wood fibres, linen, hemp, starch or other natural fibre material or a combination thereof, are mixed, optionally 20-80% by weight of the natural material may be replaced with material selected from thermoplastics, and optionally 30-70% by weight of the natural fatty acid based hybride resin may be replaced with binding agent or adhesive originating from nature, the product is formed and cured with the aid of heat at 100-250° C., and the natural fatty acid based acrylate hybride resin is manufactured by emulsion polymerisation in an aqueous emulsion of acrylate monomer onto natural fatty acid based alkyd resin.

34. The method according to claim 33 for the manufacture of a composite product, characterised in that in the method 5-30% by weight of natural fatty acid based acrylate hybride resin and 95-70% by weight of natural material or a combination thereof, are mixed, the product is formed and cured with the aid of heat at 120-200° C. to a composite product of desired type.

35. The method according to claim 33, characterised in that thermoplastics is selected from polyolefins, polyamides, polyesters, polyethyleneterephthalates (PET), polylactides (PLA) and corresponding polymers.

36. The method according to claim 33, characterised in that thermoplastics is recycled material.

37. The method according to claim 33, characterised in that the product is formed and cured by extrusion or hot-pressing.

38. The method according to claim 33, characterised in that the natural fatty acid based acrylate hybride resin is a polymer formed of acrylate monomers and natural fatty acid based alkyd resins, having a molecular weight of 800-6,000,000.

39. The method according to claim 33, characterised in that the natural fatty acid based acrylate hybride resin is manufactured by emulsion polymerisation in an aqueous emulsion of acrylate monomer onto natural fatty acid based alkyd resin in an aqueous solution in the presence of radical initiator at a temperature of 30-100° C.

40. The method according to claim 39, characterised in that the natural fatty acid based alkyd resin is selected from alkyd resins manufactured by condensing 20-80% by weight of fatty acid starting material or a mixture thereof, 1-45% by weight of one or several polyols, 10-45% by weight of one or several polybasic acids and optionally 0-15% by weight of one or several monobasic acids.

41. The method according to claim 40, characterised in that the fatty acid starting material is selected from tall oil fatty acids, suberin fatty acids, cutin fatty acids, plant oils and their mixtures, the polyol is selected from glycerol, pentaerythritol, trimethylolpropane, neopentyl glycol and their mixtures, the polybasic acid is selected from di- and polyacids and their anhydrides, and the monobasic acid is selected from valeric acid and benzoic acid

42. The method according to claim 39, characterised in that the natural fatty acid based alkyd resin is modified with maleic anhydride.

43. The method according to claim 39, characterised in that the the acrylate monomer is selected from acrylate and methacrylate monomers, acrylic acid and methacrylic acid, mixtures of acrylate monomers and mixtures of acrylate or methacrylate with styrene or vinyl alcohol or vinyl acetate.

44. The use of natural fatty acid based acrylate hybride resin or an aqueous solution/dispersion comprising it, as compatibilisator and binding agent in composite products, and the natural fatty acid based acrylate hybride resin is manufactured by emulsion polymerisation in an aqueous emulsion of acrylate monomer onto natural fatty acid based alkyd resin.
